(19) United States
(12) Patent Application Publication
(10) Pub. No.: US 2022/0083611 A1
(43) Pub. Date: Mar. 17, 2022

(54) DATA MANAGEMENT SYSTEM FOR WEB BASED DATA SERVICES

(71) Applicant: TEEJLAB INC., Burnaby (CA)

(72) Inventor: Baljeet MALHOTRA, Burnaby (CA)

(73) Assignee: TEEJLAB INC., Burnaby, BC (CA)

(21) Appl. No.: 17/422,715

(22) PCT Filed: Jan. 15, 2020
(86) PCT No.: PCT/IB2020/050279

§ 371 Date: Jul. 13, 2021

Related U.S. Application Data
(60) Provisional application No. 62/792,428, filed on Jan. 15, 2019.

(51) Int. Cl. G06F 16/958; G06F 16/953

(52) U.S. Cl. CPC G06F 16/958; G06F 16/953

(57) ABSTRACT

A computer-implemented system for detecting, collecting, curating, managing and analyzing data from various Web APIs and Web Services. A special data record is created for each detected item, that The computer-implemented system further includes sub-systems for: (1) storing the special records in a database, (2) querying the in the database to extract information for the purpose of providing but not limited to compliance, quality, reliability, and security reports and (3) visualizing the data for the purpose of analyzing it.

### FIELD OF THE INVENTION

Embodiments of the present invention relate to the field of systems for management of data from Web-based services and products such as Web Application Programming Interfaces (APIs).

### BACKGROUND OF THE INVENTION

Organizations worldwide are increasingly relying upon networked computer systems for exchanging various forms of data to enable various business and personal services. These data could be very large and may exist in many different forms and structures such as but not limited to numerical data, text data in natural languages, audio and video data. These data may be stored at different geographical locations using various technologies such as but not limited to relational databases and flat files.

Furthermore, an organization's computer systems may have hundreds or thousands of different computer applications or software (“software applications”) developed using different standards and programming languages, which may need to communicate with each other. These software applications may include those applications that are developed internally and some other applications that are developed externally by third-parties. In either case, the software applications from or of an organization may be required to exchange data with each other and/or with software applications from other organizations to enable various services. Overall, due to various forms of structured and unstructured data that are in large volumes, exchanging suitable data between heterogeneous software applications is a complex problem. Fortunately, the World Wide Web (“WWW” or “Web”) may facilitate the exchange of these data using various solutions such as Application Programming Interface(s) or API(s); for examples, (i) geographical/location information using Google Maps API, (ii) people/marketing information using Facebook Graph API, and (iii) music/entertainment information using Apple Music API. Current APIs are often referred to as “Web APIs” to distinguish them from earlier APIs that operated locally, e.g., different processes of an operating system without use of Web protocols. Those earliest APIs were generally programmatic libraries that software providers made available to allow various functionalities to be accessed by other software applications, often within the same hardware platform. With the Web and Cloud Applications, the notion of API has been extended to take advantage of the program functionalities that are available through the Web. To distinguish the present inventions from the prior art on APIs, and for economies of expression herein, important terminologies and naming conventions are introduced next.

A Web Based Data Service (herein, “WebDAS”) is a system of software/hardware and services that supports interoperable machine-to-machine interactions and/or application-to-application communication over a network such as the Web to provide data-driven software services. WebDAS may include: (1) software (such as but not limited to algorithms and techniques implemented using a computer programming language such as but not limited to Java and C++), (2) hardware (such as but not limited to computing devices, memory devices, network devices, communication devices), and (3) methods, processes, services and standards such as but not limited to communication protocols and schematic designs for software and hardware to operate in a network such as the Web. The term, “WebDAS” is intended to be understood broadly to include all marketplace forms of APIs that use the Web, “Web APIs”, “Web Services” (understood generically by the marketplace or the specific W3C definition), “Cloud APIs”, and etc. that are essentially program functionalities, which are available through the Web. For economy of expression herein, the singular version for a single instantiation (“WebDAS”) should be understood as including the plural version for several instantiations (“WebDASs” or “WebDASes”), and vice versa, as/when the context permits or suggests, with appropriate contextual changes for agreement among verb-noun-adjective-(in)definite articles. It is irrelevant how a WebDAS is designed and/or created in and by the marketplace—the present invention focuses on detecting any and all WebDASs, identifying them, curating them, managing their use, etc. In distinction to the generic, marketplace WebDAS nomenclature, the inventive contributions presented are identified by the nomenclature syntax of: [“WEBDAS” (entirely capitalized) followed by a “hyphen” and immediately by a term whose first letter is capitalized]. Specifically, the following are part of the inventive contributions, embodiments and implementations—WEBDAS-Data, WEBDAS-Metadata, WEBDAS-Responses, WEBDAS-Database, WEBDAS-Expertise, WEBDAS-Component, WEBDAS-Parameters, WEBDAS-Implementation, WEBDAS-Scan, WEBDAS-Reports, WEBDAS-Errors, WEBDAS-Tool(s), and each will, in turn, be explained further below. Accordingly, the terms of, for example, “WebDAS creator” and “WebDAS consumer”, “WebDAS user”, “WebDAS component”, WebDAS Data Key/Tag” and the like (i.e. without hyphenation and the capitalization scheme of the inventive contributions) are to be understood as marketplace actors/actions/entities/components. A WebDAS component may, after processing by the present management method disclosed herein, may become part of a WEBDAS-Component.

The invention primarily deals with the management of WebDAS regardless of how they are designed/created and by who. Organizations may design various WebDAS using APIs and/or other similar solutions that communicate over WWW using Hyper Text Transfer Protocol (HTTP) while exchanging data in JavaScript Object Notation (JSON) and/or Extensible Markup Language (XML) and/or other formats. WebDAS may also be designed using Google's Remote Procedure Call (gRPC) and/or Simple Object Access Protocol (SOAP) and/or Representational State Transfer Protocol (REST) and/or GraphQL (which is an Open Source data query and manipulation language for APIs) and/or other protocols and standards. Access to an organization's WebDAS can be controlled by organizations using various security mechanisms such as but not limited to passwords and/or secret-keys and/or access-tokens generated through OAuth (Open Authorization) standards. Examples of WebDAS are: Google Analytics API, Web services for Microsoft .Net Framework, IBM Watson Speech-to-Text API, Facebook Graph API, and many others. Note that these examples include “Web Services” and “APIs”, which may have been designed differently using different software and hardware components. It is irrelevant how a WebDAS is designed and made available to users. Herein, the terms “WebDAS vendor”, “WebDAS creator”, “WebDAS designer”, “WebDAS owner” and cognate phrasing are used interchangeably to represent individual(s) and/or organization(s) that are responsible for creating their respective WebDAS. Similarly, the terms “WebDAS user” and “WebDAS consumer” are used interchangeable to represent individual(s) and/or organization(s) that are using WebDAS. Note also that WebDAS creators and WebDAS users may or may not be the same entities, and may or may not belong to the same organizations.

Despite the complex ecosystems of software applications, data and design standards that are available, thousands of WebDAS have been created by organizations to provide useful data-driven software services. Organizations provide access to these WebDAS as free and/or paid services. Usage of WebDAS by consumers are subject to technical and/or legal requirements enforced by creators of WebDAS and/or their country of origin. While some WebDAS may be available free of cost, there may still be associated legal obligations that an organization's WebDAS users must fulfill. For example, Google Maps API is publicly available on the Web for subscription at a price or at no cost (free) under various technical and legal restrictions. Restrictions on a particular WebDAS may drastically differ from restrictions on other WebDAS depending on the functionalities of the corresponding WebDAS.

Note that Google Maps API is one of many examples of WebDAS that have this dual nature of commercial and/or freely available subscriptions, which creates unique challenges for legal compliance with various policies and regulations enforced by organizations and governments around the world. Primarily due to these challenges, managing WebDAS is an important problem for organizations (both within and their interactions with others). WebDAS compliance and/or governance may refer to the aggregation of policies, processes, training, and tools that enable organizations to effectively create and/or use WebDAS while respecting copyrights, complying with license obligations, and protecting the organizations' intellectual property and that of their customers and suppliers. Herein, “compliance” of a WebDAS refers to compliance with the legal obligations (such as “must do” and “must not do”) established by governmental/technical authority (e.g. European General Data Protection Regulation, California consumer privacy laws, technical standard of IEEE/IEE/ACM, etc.) or by contract (e.g. Terms of Service for WebDAS user). Herein, “governance” refers to the “smart inventory-ing” by an organization of its WebDAS.

The usage of WebDAS are governed by Terms of Services (ToS) and/or Statement of Privacy (SoP) and/or other legal requirements enforced by WebDAS creators/providers as well as national and/or international laws/treaties. Furthermore, technical and authorized access requirements must be met before using WebDAS. Availability of ToS, SoP, and other legal, security and technical information is very important in order for an organization to develop and/or use various WebDAS effectively in a secure and legally compliant way.

An aspect of WebDAS compliance and/or governance involves automated discovery of WebDAS metadata such as data definitions (“Data Keys” or “Data Tags”) and data elements (“Data Values”) that WebDAS use in their communications. Some examples of Data KeyNalue pairs are 355, 455, and 555, which are part of communication responses 350, 450 and 550 as shown in FIGS. 3, 4 and 5, respectively. Note that such responses are generated when specific WebDAS are implemented (“WEBDAS-Implementations”) by providing “specific” values to WebDAS parameters (“WEBDAS-Parameters”) as shown in FIGS. 3, 4 and 5, respectively for, Google Maps API, Washington State Highway API, and City of Blaine Parking API. WEBDAS-Implementations may generate various forms of metadata including but not limited to WebDAS endpoints, WebDAS creators, WebDAS authentication/access techniques as well as source and/or binary codes related to WEBDAS-Implementations. WEBDAS-Implementations may also generate WebDAS errors, which may provide useful information on using WebDAS successfully. Furthermore, WebDAS ToS, SoP and other information related to sundry technological legal or policy obligations attached to the use of WebDAS may also provide useful metadata.

In the invention disclosed herein, all such WebDAS metadata described herein are processed to create “WEBDAS-Metadata”. In the invention disclosed herein, all such WebDAS responses collected through WEBDAS-Implementations described herein are processed to create “WEBDAS-Responses”. In the invention disclosed herein, all such WEBDAS-Metadata and WEBDAS-Responses described herein are aggregated to produce “WEBDAS-Data”.

Access to such WEBDAS-Data may help WebDAS users in complying with policies and regulations even before they start to use such WebDAS. Recall that WebDAS users may be different than WebDAS creators, and hence WebDAS users may not necessarily be aware of the corresponding WEBDAS-Data. Since there are thousands of WebDAS that are already available (with the possibility of millions of WebDAS becoming available in the future), implementing all possible WebDAS in a systematic way to collect useful data is a challenging problem. In the invention disclosed herein, attention is directed toward WEBDAS-Implementations to collect and manage WEBDAS-Data in a systematic way for better characterization of various WebDAS.

Another aspect of WebDAS compliance and/or governance involves automated discovery of WebDAS from software applications. Many software applications, such as but not limited to Open Source Software (OSS) may have integrations with various WebDAS to achieve certain technical and/or business functionalities, which may increase security and/or legal and/or operational risks. Due to the popularity of OSS projects, it is conceivable that many users may be using OSS projects without knowing WebDAS that are integrated therein. A large organization may typically have tens or even hundreds of developers using various OSS and/or other software applications. Since there are millions of OSS and thousands of WebDAS that are already available with the possibility of millions of WebDAS becoming available in the future, discovery of WebDAS by manually analyzing software applications is a challenging problem. In the invention disclosed herein, attention is directed to programmatically scanning software applications in their source and/or binary code format, herein referred to as “WEBDAS-Scan”, to automatically discover various WebDAS.

Yet another aspect of WebDAS compliance and/or governance involves automated discovery of WebDAS by analyzing network traffic. It is possible that for many software applications, their corresponding source and/or binary codes may not be available. Therefore, without access to source and/or binary codes, it is not possible to scan such software applications to discover various WebDAS therein. Nonetheless, it is feasible to detect various WebDAS used and/or accessed by organizations by analyzing their network traffic. Since there are thousands of WebDAS that are already available with the possibility of millions of WebDAS becoming available in the future, discovery of WebDAS by analyzing network traffic is a challenging problem. In the invention disclosed herein, attention is directed to programmatically scanning network traffic to automatically discover various WebDAS.

Note that in all the WebDAS compliance and/or governance examples provided above, be it the need of understanding WEBDAS-Responses and/or automated discovery of WebDAS from software applications and/or automated discovery of WebDAS by network traffic analysis, the WebDAS users and WebDAS creators may be completely different entities with different business and/or technical objectives. For instance, WebDAS users may simply want to know all WebDAS used in their respective organizations for better transparency and/or billing and/or resource management perspectives. On the other hand, WebDAS creators may want to test their WebDAS to check their security posture before releasing them for public and/or private access. In summary, the compliance and/or governance objectives could vary depending on the nature of WebDAS users and WebDAS creators and their respective organizations, if any. In the invention disclosed herein, attention is directed to enabling various WebDAS users and WebDAS creators in achieving their compliance and/or governance objectives, which are discussed next.

Expertise in WebDAS management achieved through manual efforts by software developers, compliance analysts, license specialists, lawyers, and security experts may help WebDAS users in preparing various reports that are important for enabling WebDAS compliance and/or governance. These reports may include but not limited to plans of action for license and/or security and/or quality compliance, and/or auditing of bills for using third-party WebDAS. In the invention disclosed herein, attention is directed to automatically generating various WebDAS analytics and reports, herein collectively referred to as “WEBDAS-Reports”, to enable WebDAS compliance and/or governance.

The volume of WEBDAS-Metadata and WEBDAS-Responses (recall that they are collectively referred to as “WEBDAS-Data”) from all available WebDAS can be very large and require correspondingly large storage. Further, query processing and analytics of the large volume of WEBDAS-Data required to prepare WEBDAS-Reports can be complex and time consuming. For instance, a scan of a typical software project of an organization may generate tens or even hundreds of gigabytes of data containing various pieces of WEBDAS-Metadata. Even individual experts may need several days to query, analyze or evaluate manually the large volumes of WEBDAS-Data in order to prepare WEBDAS-Reports. Thus, even though software scanning tools may be used for automated detection of WebDAS from software applications, timely compliance and governance by organizations can be difficult and time consuming because the volume of WEBDAS-Data generated can be overwhelming large. In the invention disclosed herein, attention is directed to automatically generating various WebDAS Reports, to enable WebDAS compliance and/or governance.

Computer-based systems and methods for implementing WebDAS; discovering WebDAS through software application scanning and/or network traffic analysis; and analyzing WEBDAS-Data in a systematic way are disclosed herein. Attention is directed to computer-based systems and methods for generating and managing useful WEBDAS-Data for producing various WEBDAS-Reports to enable organizations in utilizing various WebDAS in a secure and compliant way, while keeping in view both the requirements for data storage and the need for speedy analysis of WEBDAS-Data generated from thousands of WebDAS available through WWW. Attention is also directed to implementing various WebDAS in a way that creates a graph of networked WebDAS that can be analyzed in a visual and exploratory way.

### SUMMARY

In accordance with one aspect of the present invention, disclosed herein is a computer-implemented method for analyzing WEBDAS-Data from source and/or binary codebase; and/or network traffic; and/or descriptions written in natural languages, comprising: (i) collecting, by a computer or network, WEBDAS-Data, each data record in WEBDAS-Data including but not limited to identification of WebDAS in source and/or binary codebase and data on one or more attributes of WebDAS; (ii) generating, by a computer, WEBDAS-Data including but not limited to identification of WebDAS providers, components, and responses by implementing WebDAS through a combination of computer programming languages; (iii) storing, by a computer, WEBDAS-Data in a database; and (iv) querying, by a computer, WEBDAS-Data stored in a database to extract information to generate WEBDAS-Reports.

In another aspect, the steps of collecting and/or generating WEBDAS-Data includes various WEBDAS-Implementations through a combination of computer programming languages; and/or scanning source and/or binary codebases; and/or analyzing network traffic to discover WebDAS.

In another aspect, the step of WEBDAS-Implementations includes systematic implementations (or instantiations, executions, calls and related actions) of thousands of WebDAS (from various vendors) in a common platform, which is a combination of software and/or hardware and/or schematic designs, to generate WEBDAS-Metadata and WEBDAS-Responses such as but not limited to the examples shown in FIGS. 3, 4 and 5.

In another aspect, the step of WEBDAS-Scan includes systematic analysis of source and/or binary codebase to detect WebDAS therein includes comparing that codebase with the codebase of known software systems and/or databases containing various WebDAS.

In another aspect, the storing of WEBDAS-Data in a database includes storing the WEBDAS-Data in a relational and/or graph database.

In another aspect, the step of querying WEBDAS-Data stored in a database to extract information to generate WEBDAS-Reports includes querying the WEBDAS-Data stored in a database using SQL queries [such as: Select*from WEDBDAS_DATA_TABLE where WEBDAS_ID=“Google”] and/or no-SQL queries [such as: def WEBDAS_DATA_GRAPH=graph.traversal( ) WEBDAS_DATA_GRAPH.Vertex( ){.hasLabel (“Google”);}].

In accordance with another aspect of the present invention, disclosed herein is a computer-implemented method for analyzing WEBDAS-Data from source and/or binary codebase; and/or network traffic; and/or descriptions written in natural languages, comprising: (i) collecting, by a computer or network, WEBDAS-Data, each data record in WEBDAS-Data including but not limited to identification of WebDAS in source and/or binary codebase and data on one or more attributes of WebDAS; (ii) generating, by a computer, WEBDAS-Data including but not limited to identification of WebDAS providers, components, and responses by implementing WebDAS through a combination of computer programming languages; (iii) storing, by a computer, WEBDAS-Data in a graph database; and (iv) querying, by a computer, WEBDAS-Data stored in a graph database to extract information to generate WEBDAS-Reports.

In another aspect, the step of generating and/or receiving WEBDAS-Data includes implementing various WebDAS through a combination of computer programming languages; and/or scanning source and/or binary codebase; and/or analyzing network traffic to discover WebDAS.

In another aspect, the step of implementing WebDAS includes systematic implementations of thousands of WebDAS from various vendors in a common platform, which is a combination of software and/or hardware and/or schematic designs, to generate WEBDAS-Data including WEBDAS-Responses such as but not limited to the examples shown in FIGS. 3, 4 and 5.

In another aspect, the step of scanning source and/or binary codebase to detect WebDAS therein includes comparing that codebase with the codebase of known software systems and/or databases containing various WebDAS.

In another aspect, the step of storing the WEBDAS-Data in a graph database includes modeling the WEBDAS-Data as a graph characterized by vertices, edges and other properties.

In another aspect, the step of querying WEBDAS-Data stored in a graph database to extract information to generate WEBDAS-Reports includes querying the WEBDAS-Data stored in a graph database using Graph Query Language (“GQL”) queries [such as but not limited to the example of: def WEBDAS_DATA_GRAPH=graph.traversal( ) WEBDAS_DATA_GRAPH.Vertex( ){.hasLabel (“Google”);}].

In accordance with another aspect of the present invention, disclosed herein is a system for analyzing WEBDAS-Data from source and/or binary codebase; and/or network traffic; and/or descriptions written in natural languages, the system comprising a memory and a semiconductor-based processor, the memory and the processor forming one or more logic circuits configured to: (i) collecting, by a computer or network, WEBDAS-Data, each data record in WEBDAS-Data including but not limited to identification of WebDAS in source and/or binary codebase and data on one or more attributes of WebDAS; (ii) generating, by a computer, WEBDAS-Data including but not limited to identification of WebDAS providers, components, and responses by implementing WebDAS through a combination of computer programming languages; (iii) storing, by a computer, WEBDAS-Data in a database; and (iv) querying, by a computer, WEBDAS-Data stored in a database to extract information to generate WEBDAS-Reports.

In another aspect, the logic circuits are configured to implement thousands of WebDAS provided by various vendors to generate WEBDAS-Responses such as but not limited to the examples shown in FIGS. 3, 4 and 5.

In another aspect, the logic circuits are configured to scan source and/or binary codebase to discover WebDAS.

In another aspect, the logic circuits are configured to analyze network traffic to discover WebDAS.

In another aspect, the logic circuits are configured to store discovered WEBDAS-Data in a relational database.

In another aspect, the logic circuits are configured to store discovered WEBDAS-Data in an in-memory relational database.

In another aspect, the WEBDAS-Data is modeled as a graph characterized by vertices, edges and other graph properties, and wherein the logic circuits are configured to store the modeled graph in a graph database.

In another aspect, the WEBDAS-Data is modeled as a graph characterized by vertices, edges and other graph properties, and wherein the logic circuits are configured to store the modeled graph in an in-memory graph database.

In another aspect, the logic circuits are further configured to query the WEBDAS-Data stored in a relational database and/or in-memory relation database to extract information to generate WEBDAS-Reports using SQL and/or no-SQL queries.

In another aspect, the logic circuits may be further configured to query the WEBDAS-Data stored in a graph database and/or in an in-memory graph database to extract information to generate WEBDAS-Reports using GQL-queries.

The details of one or more implementations are set forth in the accompanying drawings and the description below. Further features of the disclosed subject matter, its nature and various advantages will be more apparent from the accompanying drawings, the following detailed description, and the claims.

### BRIEF DESCRIPTION OF THE DRAWINGS

The advantages of the invention may be better understood with reference to the following drawings, in accordance with the principles of the present disclosure. The drawings are to be understood as exemplary (whether explicitly stated to be or not) rather than limiting (as the scope of the invention is defined by the claims).

FIG. 1 is a schematic block diagram illustration of a Data Management and Analytics System for collecting, managing and analyzing WEBDAS-Data, which are stored in a Relational Data Base Management System (RDBMS).

FIG. 2 is a schematic block diagram illustration of a Data Management and Analytics System for collecting, managing and analyzing WEBDAS-Data, which are stored as a graph structure in a Graph Database Management System (GDBMS).

FIG. 3 is a schematic illustration of WEBDAS-Example of “Google Maps API” with WEBDAS-Metadata (such as parameters and URL) and WEBDAS Responses, collectively referred to as WEBDAS-Data.

FIG. 4 is a schematic illustration of a WEBDAS-Example of “Washington State Highway API” with WEBDAS-Metadata (such as parameters and URLs) and WEBDAS-Responses, collectively referred to as WEBDAS-Data.

FIG. 5 is a schematic illustration of a WEBDAS-Example of “City of Blaine Parking API” with WEBDAS-Metadata (such as parameters and URLs) and WEBDAS-Responses, collectively referred to as WEBDAS-Data.

FIG. 6 is a schematic illustration of a WEBDAS-Example of “iTunes Artist API” with WEBDAS-Metadata (such as parameters and URLs) and WEBDAS Responses, collectively referred to as WEBDAS-Data.

FIG. 7 is a schematic illustration of a WEBDAS-Example of “Phone Lookup API” with WEBDAS-Metadata (such as parameters and URLs) and WEBDAS Responses, collectively referred to as WEBDAS-Data.

FIG. 8 is a schematic illustration of a WEBDAS-Example of “Twitter Search API” with WEBDAS-Metadata (such as parameters and URLs) and WEBDAS-Responses, collectively referred to as WEBDAS-Data.

FIG. 9 shows an example graph constructed from an example WEBDAS modelled as vertices and vertex attributes summarized in the corresponding table.

FIG. 10 shows “WebDAS Vendors” based relationship graph constructed from an example WebDAS modelled as vertices and vertex attributes summarized in the corresponding table.

FIG. 11 shows an example method for collecting, managing and analyzing information (“WEBDAS-Data”) and then used for computer systems and/or software products of an organization.

FIG. 12 shows “WebDAS Category” based relationship graph constructed from an example WebDAS modelled as vertices and vertex attributes summarized in the corresponding table.

FIG. 13 shows an example WEBDAS-Report—Governance.

FIG. 14 shows an example WEBDAS-Report—Security.

FIG. 15 shows an example WEBDAS-Report—Compliance.

FIG. 16 shows an example WEBDAS-Report—Errors.

FIG. 17 shows an example WEBDAS-Component.

FIG. 18 shows examples of WEBDAS-Metadata. In particular, 1835, 1845, 1855, 1865, and 1875 form a collection of WEBDAS-Metadata, respectively, representing software application name, number of discovered WebDAS, name of WebDAS, name of WebDAS creator, and the file location related to WebDAS code.

### DETAILED DESCRIPTION

Computer-implemented systems and methods (collectively “solutions”) for collecting, generating, managing and analyzing WEBDAS-Data from computer networks and/or systems and/or software applications are described herein.

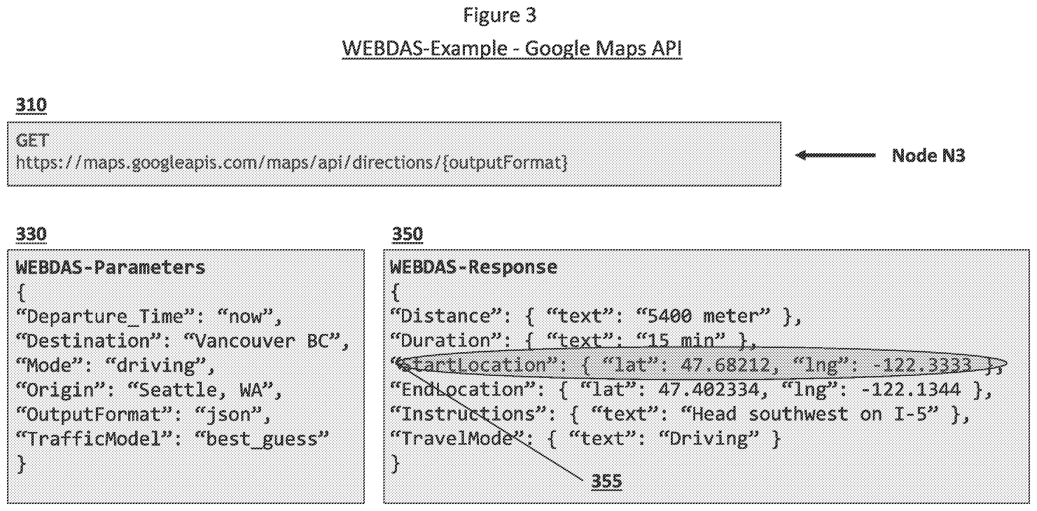

WEBDAS-Data may, for example, include WEBDAS-Responses (such as but not limited to the examples shown in FIGS. 3, 4 and 5) containing Data Keys (or Tags) and Data Values generated by WEBDAS-Implementations, identification of various WebDAS discovered from software applications, network traffic, directory locations (e.g., folder, files, sub-folders, etc.) of discovered WebDAS, information on potential origins of WebDAS, legal notices (licenses), and/or other information related to various technological, legal and policy obligations of using various WebDAS. The WEBDAS-Data may be used to prepare WEBDAS-Reports, which may also include action plans directed toward ensuring compliance with legal and/or technical obligations and/or policies of organizations and laws of the land related to the use of WebDAS in an organizations' computer systems and/or software applications.

The solutions may involve using available computer software and/or hardware and/or architectural designs to implement various WebDAS in a systematic way regardless of how various WebDAS are designed and/or created by their respective vendors. The solutions described herein may also involve using software scanning tools to scan the codebase of computer systems and/or software applications to generate WEBDAS-Data. The solutions described herein may also involve using tools for analyzing communication network (traffic) to discover WebDAS. The software scanning tools may include, for example, tools that are available for free from non-profit organizations (e.g., Linux Foundation) or tools that are available from commercial vendors (e.g., Antelink, Palamida, Protecode, Black Duck Software, nexB, OpenLogic, etc.). The solutions may also involve scanning tools to scan the codebase of computer systems and/or software applications to generate appropriate WEBDAS-Data, which are not possible to generate through existing free and/or commercial software scanning tools. The solutions may also involve new network analysis tools to monitor communication traffic to detect various WebDAS and their characteristics to generate WEBDAS-Data therefrom, which may not be possible to extract through existing free and/or commercial network analysis tools.

WEBDAS-Data generated by systematic implementations of thousands of WebDAS in a single platform, which is a combination of software and/or hardware and/or schematic designs, may include but not limited to WEBDAS-Responses containing the values generated by WEBDAS-Implementation of a subject, discovered WebDAS in response to WEBDAS-Parameters. The WEBDAS-Data may also include scan results generated by software scanning tools and/or network analysis tools. The scan results may identify or describe the provenance of various WebDAS discovered from software applications and/or computer networks by matching the identification/information of discovered WebDAS with already known WEBDAS-Data, which may be stored, for example, in a WEBDAS-Database.

A high degree of redundancy may be inherent in the software scan results generated from a software codebase. Each WebDAS discovered from the scanned software codebase may, for example, be matched to one or more already known WebDAS in the WEBDAS-Database. Furthermore, many of the detected WebDAS from the scanned software codebase may, for example, be duplicative or repetitive or may have the same source of origin or provenance. Thus, the software scan results, which identify or describe the provenance of various WebDAS, may include similar, duplicative, or redundant pieces of information.

In one aspect, recognizing the degree of redundancy inherent in the software scan results, the solutions for collecting, managing and analyzing WEBDAS-Data described herein may involve data compression of the WEBDAS-Data. In particular, the solutions may utilize column-based storage or row-based storage to achieve data compression, in accordance with the principles of the disclosure herein. This data compression may reduce the size of the WEBDAS-Data that needs to be stored. The column-based storage described herein may exploit the data redundancy in the WEBDAS-Data to achieve significant data compression thereof.

In another aspect, the solutions for collecting, managing and analyzing WEBDAS-Data described herein may use graph-based modeling techniques to model and store WEBDAS-Data as graph structures for query processing and analytics, in accordance with the principles of the disclosure herein. WEBDAS-Data may be stored in a graph database as modeled graph structures characterized by vertices or nodes, edges, and properties of nodes and/or edges. The modeled graph structures may be stored in representations that are amenable or suitable for semantic queries.

A column-based and/or row-based, Relational Database Management System (RDBMS) may be used as a platform to implement the solutions, in accordance with the principles of the disclosure herein, for collecting, managing and analyzing WEBDAS-Data. In example implementations, a relational database management system may be utilized to store WEBDAS-Data, for example, in a column-based database or a graph database. Furthermore, a query processing engine may be configured for real-time query processing of WEBDAS-Data stored in column-based or graph databases.

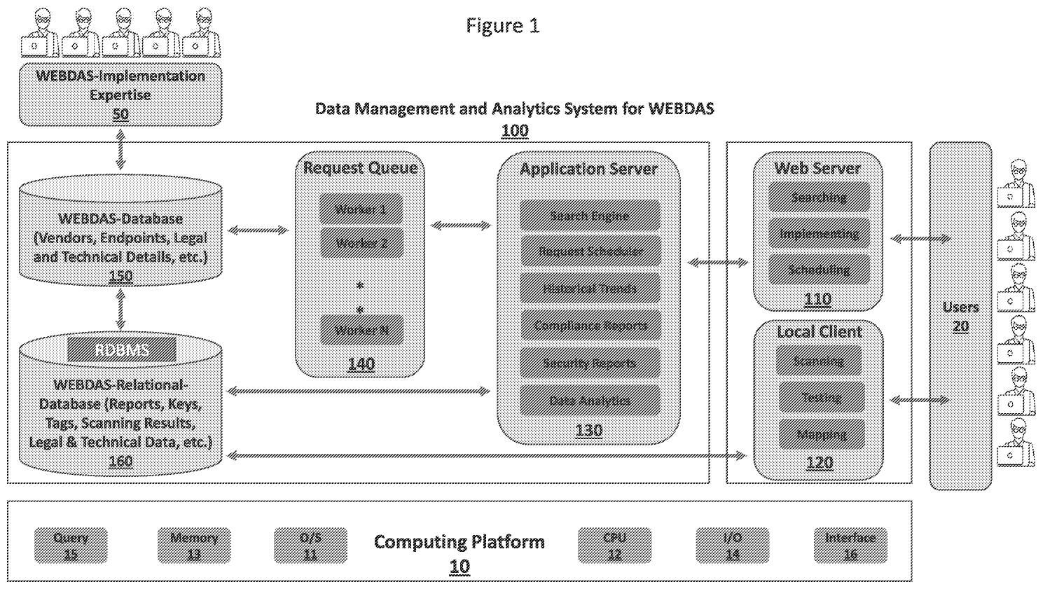

FIG. 1 shows an example implementation of Data Management and Analytics System 100, which may include an example Relational Database Management System (RDBMS) 160 for collecting, managing and analyzing WEBDAS-Data, in accordance with the principles of the disclosure herein.

FIG. 1 shows an example implementation of Data Management and Analytics System 100 containing one or more modules, for example, Web Server 110, Local Client 120, Application Server 130, Request Queue 140, WEBDAS-Database 150, Relational Database Management System (RDBMS) 160 for storing WEBDAS-Data. Application Server 130 provides one or more functions, for example, a search engine for WebDAS, executing, scheduling searching WebDAS instances, providing historical trends, security, compliance reports and/or data analytics. WEBDAS-Implementation Expertise 50 provides an interface to add WebDAS related information to WEBDAS-Database 150, which is coupled with RDBMS 160. Users 20 interact with System 100 through Web Server 110 and Local Client 120 to perform various operations via Application Server 130, for example, WEBDAS-Implementations, code scans, code analysis, legal and security reports management, and data and visual analytics that are configured to provide one or more functions that may be used for WEBDAS-Reports for reliability, billing, compliance, quality, and security processes and/or for managing WEBDAS-Data.

FIG. 1 shows an example implementation of Web Server 110 utilized by users 20 for implementing (and/or instantiating or executing) WebDAS created by various organizations. Web Server 110 also provides functions, for example, initiating WebDAS searches and/or implementing WebDAS and/or executing/scheduling already implemented WebDAS instances and/or scanning software applications to discover WebDAS. Web Server 110 coupled with Application Server 130 provides functions, for example, executing searches issued by users 20, scheduling/executing WebDAS instantiated by users 20, providing historical trends, security/compliance reports and/or various data analytics related to various WebDAS implementations. Each implementation and/or execution and/or scheduling of WebDAS becomes a source for WEBDAS-Data stored in RDBMS 160 coupled with Application Server 130.

FIG. 1 shows an example implementation of Local Client 120 coupled with RDBMS 160. Local Client 120 generates WEBDAS-Data, for example, by scanning and/or testing and/or mapping a user 20 organization's computer system/software to detect and identify various WebDAS and related information therein. Local Client 120 may provide the generated WEBDAS-Data to RDBMS 160 for processing, for example, by Data Management and Analytics System 100.

FIG. 1 shows an example implementation of Services Interface 16 as a Web Services interface, which provides communication links to external devices (e.g., Local Client 120, RDBMS 160, etc.) via the Internet. Local Client 120 may be a computing device (e.g., a laptop computer, a desktop computer, a mobile computing device, etc.) via which a user can interact with one or more functions of System 100 launched on Computing Platform 10.

FIG. 1 shows an example implementation of RDBMS 160 that may be hosted on or distributed over one or more physical machines in a computer network, for example, but not limited to the Web. For visual clarity, FIG. 1 shows RDBMS 160 hosted, for example, on a Computing Platform 10, which includes O/S 11, CPU 12, memory 13, and I/O 14. Although Computing Platform 10 is shown in the example of FIG. 1 as a single computer, Computing Platform 10 may represent two or more computers in communication with one another in a computer network. Similarly, any two or more components of system 100 may be executed using some or all of the two or more computers in communication with one another. Conversely, it also may be appreciated that various components shown as being external to Computing Platform 10 may actually be implemented therewith or therein.

RDBMS 160 may include computing platform 10 on which system 100 may be launched. Computing platform 10 may include or be coupled to one or more platform components (e.g., Interface 16, Query Processing unit 15, I/O unit 14, Memoryt 13, a CPu 12, 0/S 11), which may support or enable the various functions of application 100. Query Processing unit 15 may be configured for real-time processing of WEBDAS-Data stored in the column-based and/or graph database. RDBMS 160 may, for example, be an in-memory database and/or may be configured to process and compress WEBDAS-Data for storage, for example, attribute-by-attribute or column-by-column in RDBMS 160.

As noted previously in an alternative example implementation of the solutions for collecting, managing and analyzing WEBDAS-Data described herein, WEBDAS-Data may be modeled as a graph structure and stored as such in a graph database for query processing and analytics, in accordance with the principles of the disclosure herein. WEBDAS-Data may be stored in a graph database as a graph structure with nodes, edges, and other graph properties to represent the underlying WebDAS metadata and WEBDAS-Data. The graph structure may be amenable or suitable for semantic queries related to WEBDAS analytics and reports.

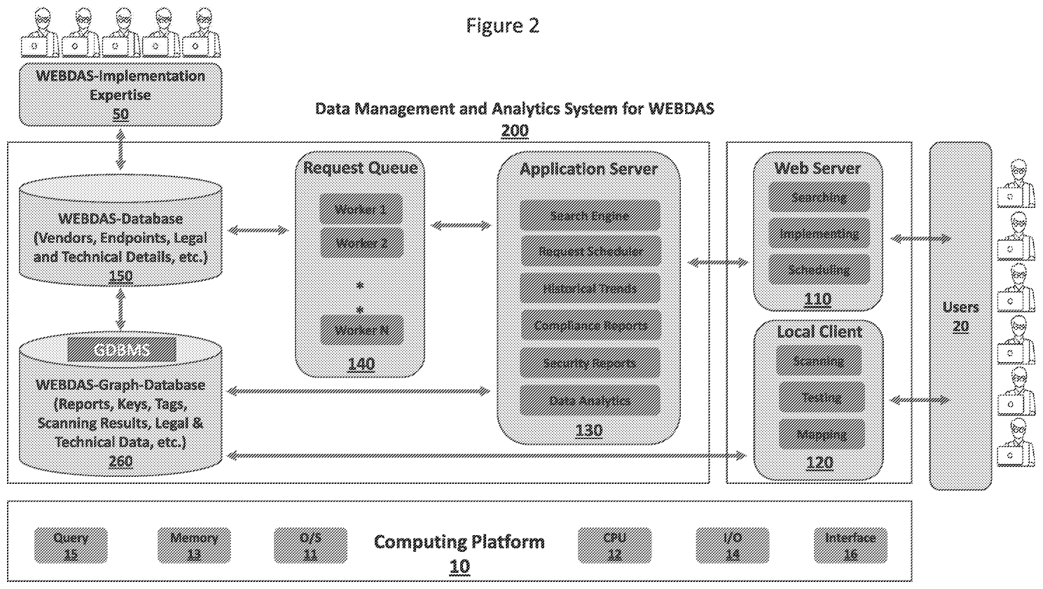

FIG. 2 shows an example implementation of Data Management and Analytics System 200 for collecting, managing and analyzing WEBDAS-Data using a Graph Database Management System (GDBMS) 260. WEBDAS-Data are stored as graph structures in GDBMS, in accordance with the principles of the present disclosure. Several of the components of system 200 may be the same or similar to the components of system 100 shown in FIG. 1 and for brevity, the description of such same or similar components is not repeated herein. Note that in system 200, WEBDAS-Data may be stored in a Graph Database Management System (GDBMS) 260, which like RDBMS 160, may be an in-memory database. WEBDAS-Data may reside in an in-memory graph database GDBMS 260 or in a persistence storage layer (not shown) for backup to the extent possible. Furthermore, GDBMS 260 may include one or more modules, for example, O/S 11, CPU 12, Memory 13, I/O unit 14, Query Processing unit 15, Interface 16 to process WEBDAS-Data.

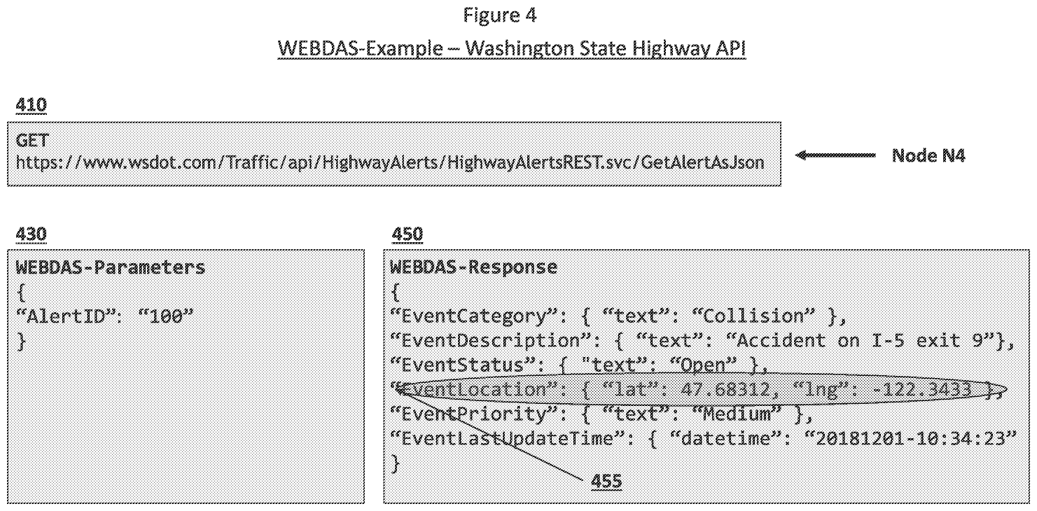

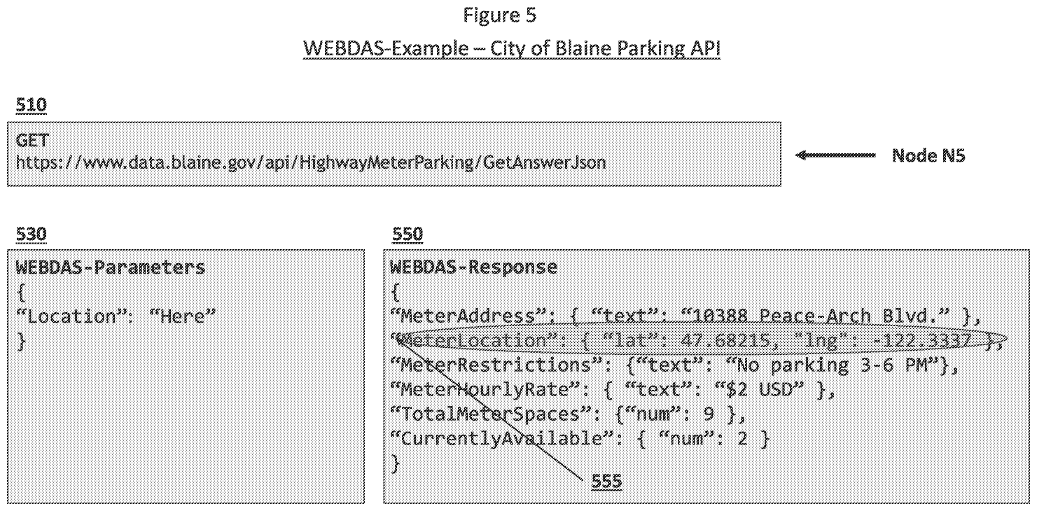

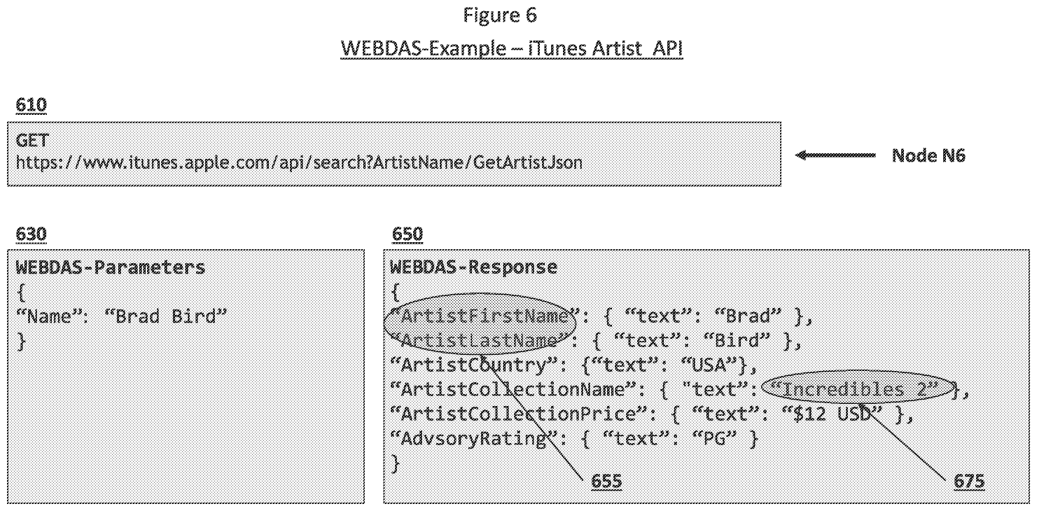

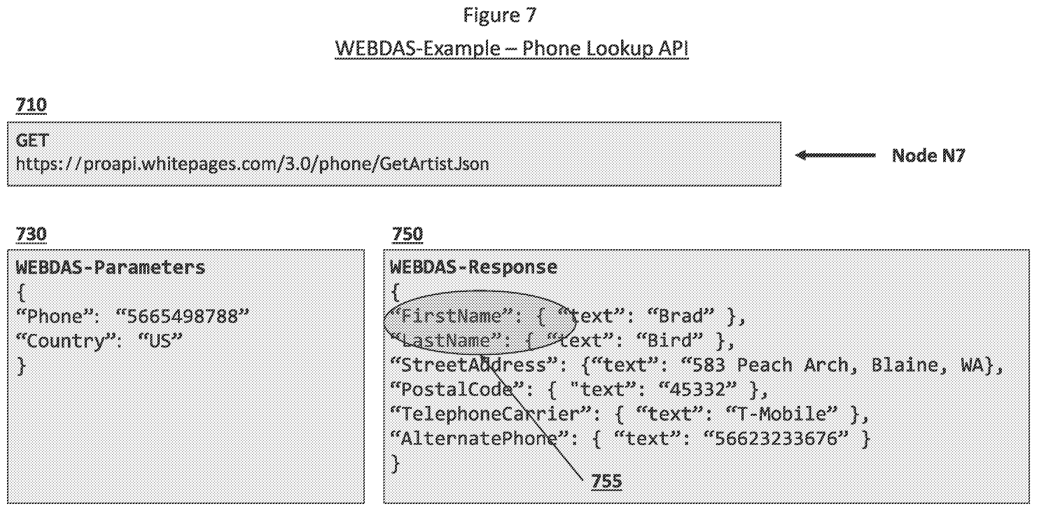

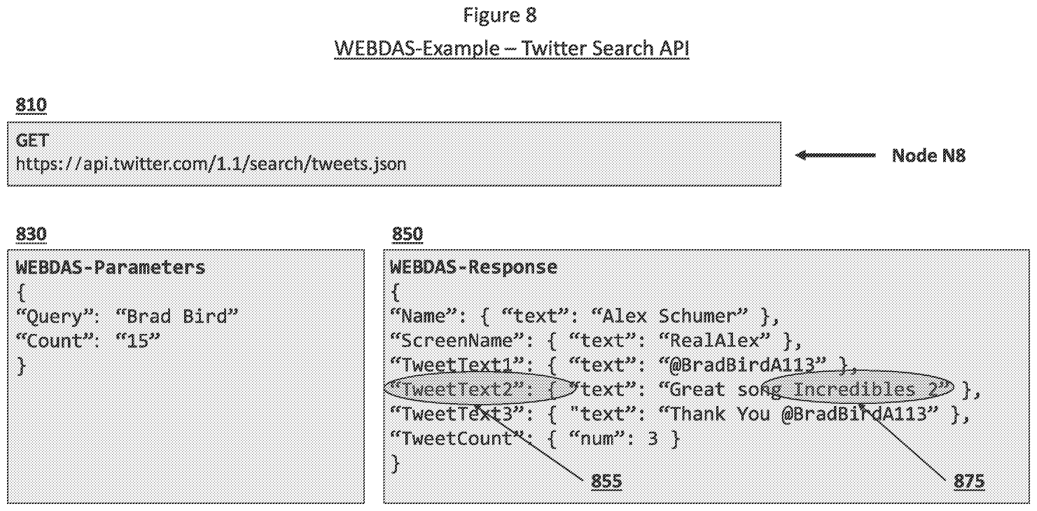

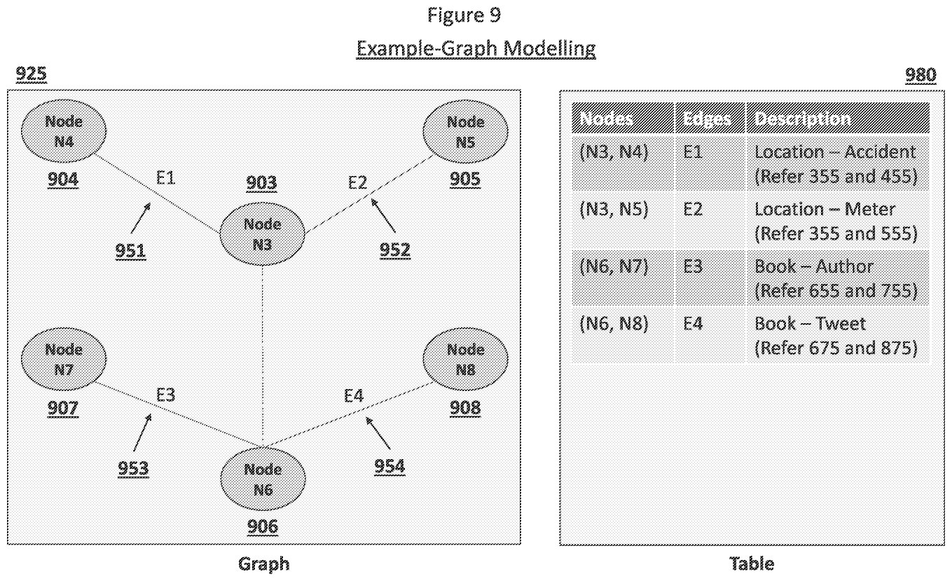

In system 200, WEBDAS-Data may be modeled as a graph (e.g., a hierarchical tree structure) characterized by nodes (also known as vertices) and edges. FIG. 9 shows an example Graph 925 modelled from six real world examples of WebDAS described in FIGS. 3 to 8. Typically, a WebDAS has a method, e.g., “Get” (endpoint or method), a set of inputs, e.g., “WEBDAS-Parameters”, and a set of outputs, e.g., “WEBDAS-Response”. FIG. 3 shows a WEBDAS-Example for WebDAS “Google Maps API” 310 modelled as Node 903 in FIG. 9. FIG. 4 shows a WEBDAS-Example for WebDAS “Washington State Highway API” 410 modelled as Node 904 in FIG. 9. FIG. 5 shows WEBDAS-Example for “City of Blaine Parking API” 510 modelled as Node 905 in FIG. 9. FIG. 6 shows a WEBDAS-Example for WebDAS “iTunes Artist API” 610 modelled as Node 906 in FIG. 9. FIG. 7 shows a WEBDAS-Example for WebDAS “Phone Lookup API” 710 modelled as Node 907 in FIG. 9. FIG. 8 shows a WEBDAS-Example for WebDAS “Twitter Search API” 810 modelled as Node 908 in FIG. 9.

Referring to FIG. 3 (as illustrative of WEBDAS-Examples (in FIGS. 4-8)), endpoint 310 is obtained from a WebDAS metadata; WEBDAS-Parameters 330 shows WebDAS metadata (e.g. “Departure_Time”) implemented with the value of “now”; and the resulting WEBDAS-Response 350 shows the pair 355 of Data Tag/Key (of “Start Location”) and values generated {“lat”: 47.68212, “Ing”: −122,333}).

FIG. 9 shows an example Graph 925 (in the form of a hierarchical tree structure) modeled from WEBDAS-Data summarized in Table 980 to represent, e.g., the relationships between Nodes 903, 904, 905, 906, 907 and 906.

FIG. 9 shows an example edge E1 951 representing the relationship between Node 903 and Node 904 modeled from WEBDAS-Data extracted from WEBDAS-Response 350 in FIG. 3 and Response 450 in FIG. 4. Both Responses may share common location information provided through, e.g., “StartLocation” 355 in FIG. 3 and “EventLocation” 455 in FIG. 4.

FIG. 9 shows an example edge E2 952 representing the relationship between Node 903 and Node 905 modeled from WEBDAS-Data extracted from WEBDAS-Response 350 in FIG. 3 and Response 550 in FIG. 5. Both Responses may share common location information provided through, e.g., “StartLocation” 355 in FIG. 3 and “MeterLocation” 555 in FIG. 5.

FIG. 9 shows an example edge E3 953 representing the relationship between Node 906 and Node 907 modeled from the WEBDAS-Data extracted from WEBDAS-Response 650 in FIG. 6 and WEBDAS-Response 750 in FIG. 7. Both Responses may share common name information provided through, e.g., “ArtistFirstName ArtistLastName” 655 in FIG. 6 and “FirstName LastName” 755 in FIG. 7.

FIG. 9 shows an example edge E4 954 representing the relationship between Node 906 and Node 908 modeled from the WEBDAS-Data extracted from WEBDAS-Response 650 in FIG. 6 and Response 850 in FIG. 8. Both WEBDAS-Responses may share common information provided through, e.g., “Incredibles 2” 675 in FIG. 6 and “Great Song Incredibles 2” 875 in FIG. 8.

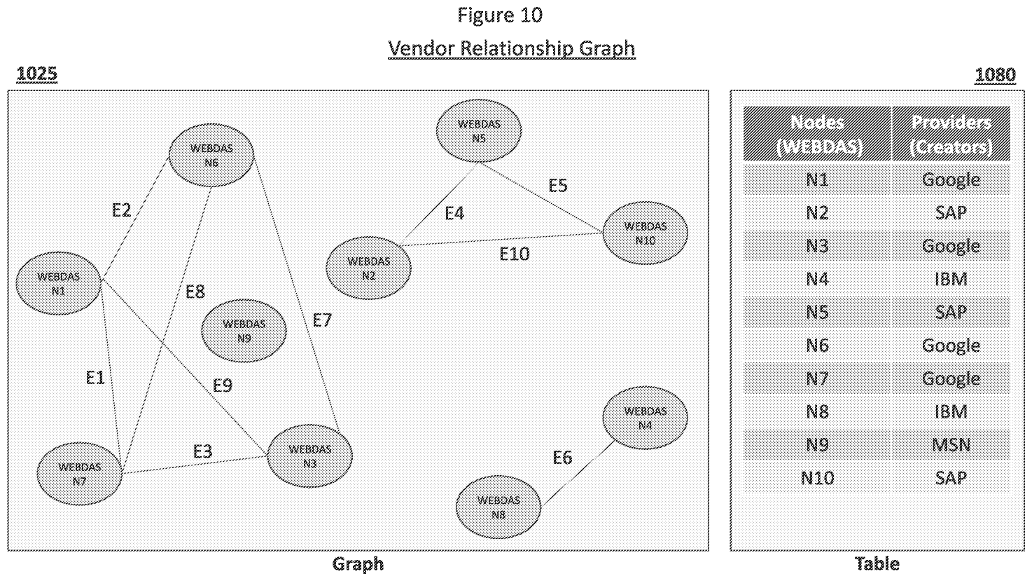

FIG. 10 shows an example Graph 1025 modeled from WEBDAS provided by vendors, for example Google, SAP, IBM, MSN. Example of WEBDAS-Data used for modeling the Graph 1025 are summarized in Table 1080. Example WEBDAS in Graph 1025 are modeled as Nodes N1, N2, N3, N4, N5, N6, N7, N8, N9, N10 as shown in FIG. 10. Example Edges E1, E2, E3, E7, E8, E9 in Graph 1025 connect Nodes N1, N3, N6, N7 with each other to model the fact that the corresponding WebDAS belong to Google as shown in Table 1080. Similarly, example Edges E4, E5, E10 in Graph 1025 connect Nodes N2, N5, N10 with each other to model the fact that the corresponding WebDAS belong to SAP as shown in Table 1080. Similarly, example Edge E6 in Graph 1025 connect Nodes N4 and N8 to model the fact that the corresponding WebDAS belong to IBM as shown in Table 1080. WEBDAS Node N9 is not connected with any other Nodes in the Graph 1025 as no other nodes represent WebDAS from MSN in this example. Graphs similar to 1025 can be formed using different criteria, for example, categories of WebDAS based on countries of WebDAS origins.

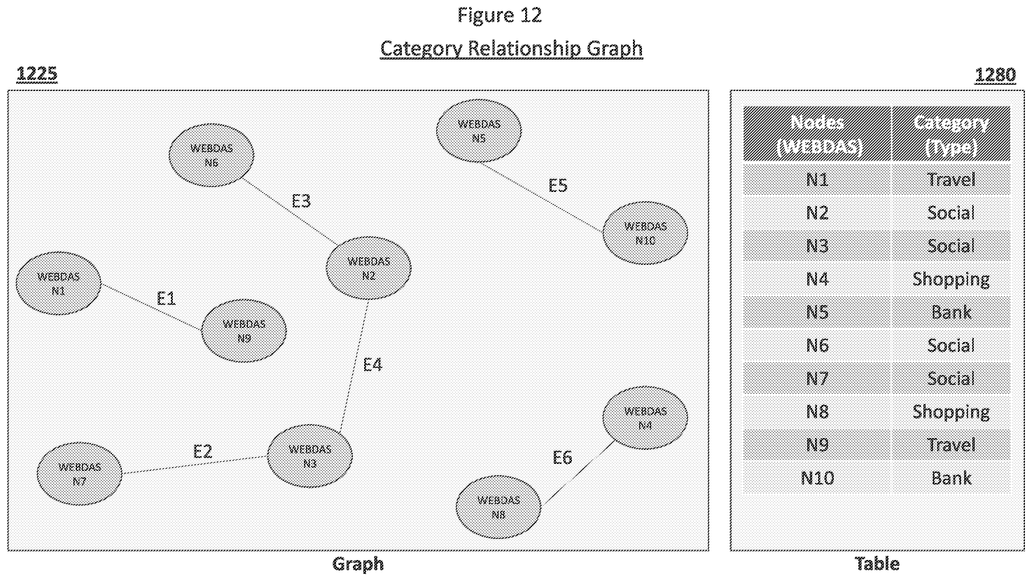

FIG. 12 shows an example Graph 1225 modeled from example WEBDAS modeled as Nodes N1, N2, N3, N4, N5, N6, N7, N8, N9, N10 as shown in FIG. 12. Example of WEBDAS-Data used for modeling the Graph 1225 are summarized in Table 1280. Example Edges E2, E3, E4 shown in Graph 1025 connect Nodes N2, N3, N6, N7 with each other to model the fact that the corresponding WebDAS belong to “Social” category or type as shown in Table 1280. Similarly, example Edge E1 in Graph 1225 connect Nodes N1 and N9 to model the fact that the corresponding WebDAS belong to “Travel” category or type. Example Edge E5 in Graph 1225 connect Nodes N5 and N10 to model the fact that the corresponding WebDAS belong to “Bank” category or type as shown in Table 1280. Similarly, example Edge E6 in Graph 1225 connect Nodes N4 and N8 to model the fact that the corresponding WebDAS belong to “Shopping” category as shown in Table 1280. It is conceivable that graphs like 1225 can be formed using different criteria, for example, WebDAS countries of origin, licenses and policies.

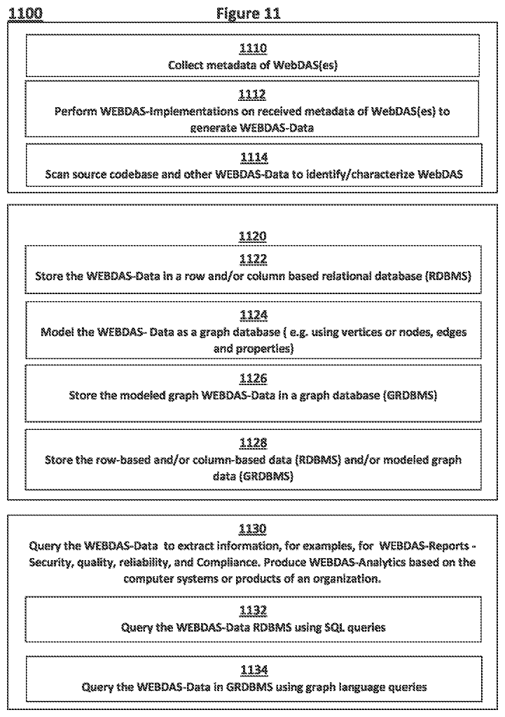

FIG. 11 shows an example method 1100 for collecting, managing and analyzing various forms of information (“WEBDAS-Data”) derived from a great plurality of WebDASs: (1) by implementing (and/or executing and/or instantiating) various WebDAS (created by various organizations), and (2) from source codebase of computer systems and/or software products of organizations, in accordance with the principles and of the disclosure herein. The collecting, managing and analyzing WEBDAS-Data may be directed to extract information related to but not limited to compliance, security, quality, billing, reliability matters related to various WebDAS and/or software systems and/or software applications.

Each data record in WEBDAS-Data may include identification of various WebDAS including but not limited to WEBDAS vendors, WEBDAS-Responses, WEBDAS-Parameters, WEBDAS-Errors and/or other attributes that identify various WebDAS. These other attributes may, for example, describe directory locations of WebDAS integrations, identification of known WebDAS detected from source and/or binary codes and/or software applications, potential origins of the detected WebDAS component, legal notice (licenses) attached to the WebDAS components, and other information related to various technological legal or policy obligations of using the WebDAS components in the source code or binary codebase of the computer systems and/or software products and services of the organizations.

Method 1100 includes generating and receiving, by a computer and/or network such as the Internet, WEBDAS-Data (1110), storing the WEBDAS-Data in a database (1120), and querying WEBDAS-Data stored in the database to extract information, for example, to prepare a WEBDAS compliance and/or security and/or quality and/or reliability reports (WEBDAS-Reports) for the source or binary codebase of the computer systems or software products and/or services of the organization (1130).

In method 1100, receiving the WEBDAS-Data 1110 may include implementing and/or executing and/or instantiating WEBDAS created by various organizations (1112), scanning/analyzing the network traffic and/or source codebase and/or software applications to detect WEBDAS therein (1112). The scanning may involve comparing the source and/or binary codebase of software applications with the codebase and/or database of known WEBDAS, which may, for example, be listed in a WEBDAS-Database containing WEBDAS-Data.

In an example implementation of method 1100 described herein, storing WEBDAS-Data in a database (1120) may include storing the received WEBDAS-Data in a column-based and/or row-based relational database (1122). The row-based relational database and/or column-based relational database may, for example, be a real time in-memory database (1128). Storing the WEBDAS-Data records attribute-by-attribute or column-by-column in a column-based in the relational database may compress the size of the received WEBDAS-Data, which may be expected to have a high degree of redundancy. Further, querying WEBDAS-Data stored in a database to extract information, for example to prepare a WEBDAS-Report for the source or binary codebase of the computer systems and/or software products of organizations (1130). Querying WEBDAS-Data stored in the row-based and/or column-based relational database may use SQL queries (1132).

In an alternate example implementation of method 1100 described herein, storing the WEBDAS-Data in a database (1120) may include modeling the received WEBDAS-Data as a graph structure (1124), which may be described by vertices or nodes, edges and other graph properties. Storing the WEBDAS-Data in database (1120) may include storing the modeled graph structure in a graph database (1126). A graph database may, for example, be a real time in-memory database. In an example implementation, a modeled graph structure may be stored in an in-memory graph database (1128). Further, querying WEBDAS-Data stored in a graph database to extract information, for example to prepare a WEBDAS-Report for the source or binary codebase of the computer systems and/or software products of organizations (1130). Querying WEBDAS-Data stored in a graph database may use GQL queries and/or no-SQL queries (1134).

Method 1100 may be implemented in conjunction with one or more of a Computing Platform 10 (containing various combinations of O/S 11, CPU 12, Memory 13, I/O 14, Query Engine 15, Interface Driver 16), Database Systems (e.g., RDBMS 160 and/or GRDBMS 260 as shown in FIGS. 1 and 2), Web Server 110 (providing WEBDAS-Scan, WEBDAS-Implementation, WEBDAS-Scheduling services), Local Client 120 (providing Software Scanning, Testing, Mapping services), WEBDAS-Database 150 that includes a listing of known WebDAS. Various functions of method 1100 may be user-controlled or interactively performed by users 20 and/or WEBDAS Experts (Expertise), for example, via Web Server 110, Local Client 120 of system 100 and system 200).

The activity of discovering instances or presences of WebDAS may be described with related (and often interchangeable) terms such as “detecting”, “scanning”, “identifying” and their cognate variations. The term “WEBDAS-Scan” herein means any conventional Web search engine technologies (as they may develop) for instances of WebDAS(es), enhanced by intelligent functionalities described herein, for searching on (1) the (public) Web or within (2) the (non-public or private) software and products of organizations (with their permission). These enhanced functionalities are automated, and as will be described below, enhance the detection and proper characterization of every WebDAS which are otherwise detected by conventional technologies.

The term “metadata” encompasses descriptive metadata (e.g. a resource for purposes such as discovery and identification), structural metadata (e.g. how the subject data is organized into its constituent parts) and administrative metadata (e.g. rights management, legal licenses).

Each (candidate or detected instance of) WebDAS has its metadata schema (as created and known by its creator, and is wholly/partially/easily discoverable/inferable or not) with (some or all associated) metadata (of the types described above). Typically a WebDAS metadata is minimally discoverable—some “natural language” data (e.g. its name and perhaps a license agreement), its endpoint (or a method of call), a security status (e.g. its authentication requirement) and perhaps a few other parameters with some discoverable values.

From each and for each WebDAS and its metadata, the “smart scanning” creates its associated WEBDAS-Data, and specifically, its WEBDAS-Metadata and WEBDAS-Responses (stored in WEBDAS Database 150). WEBDAS-Metadata has two types of metadata. The first type is termed “WebDAS metadata”, being (or extracted from) its discoverable metadata (as described above). Typically, this is a short list of parameters/attributes, whether public (e.g. Open Source Software available on the Web) or private (an organization's proprietary WebDAS, discovered with permission). The second type is termed “WEBDAS-Metadata” and is the aforementioned first type (i.e. WebDAS metadata to the extent discoverable) plus (through “smart functionality”) additional metadata derived from WebDAS metadata (e.g. a higher level categorization of the detected WebDAS as related to Travel, Shopping, Social shown in FIG. 12)) and additional metadata generated by implementing/executing the detected WebDAS with prescribed parameter/metadata values (e.g. WEBDAS-Responses and network traffic). So, through these enhanced functionalities, the WEBDAS-Metadata is a re-creation of the WebDAS metadata with some additional parameters (WEBDAS-Parameters) that are inferred or synthesized (by intelligent inferences), so that a subject WebDAS-Metadata and associated WEBDAS-Responses, represents a good characterization of that WebDAS, and specifically a good version of the parameters for that WebDAS which is otherwise only known to its developer.

Accurate characterization of a detected WebDAS is important. First, the entirety of WebDAS instances discoverable on the Web is voluminous (and increasing) and defies hardware/software resources to detect and manage—and only with proper characterization of each WebDAS instance, can, for example, redundancies be detected (to varying degrees of similarity/identity) and thereby eliminated. Secondly, only after proper characterization of a WebDAS instance can additional metadata (the aforementioned “WEBDAS-Metadata”) be reliably generated therefrom—e.g. to perform classification/categorization into subjects like travel, shopping, social.

For the foregoing activities, a standardized characterization of a WebDAS and its metadata and metadata schema, is developed on an WebDAS-specific basis (or a WebAPI specific or Web Services specific basis). Derived from the preceding, an example of standardized WEBDAS-Metadata scheme is {authentication, endpoint, “natural language” description, parameters list (required, optional, additional)}. A combination of standardized, normalized characteristics allows, for example, two (different looking) WebDASs (WebAPI1 and WebAPI2) to be identified (with a percentage level of confidence) that they are really the same WebDAS or (in the opposite scenario) allows two WebAPI3 and WebAPI5) that have some similarities (e.g. “natural language” discovery metadata both have the “keyword” of “translation” or “travel”) to be identified as distinctly different WebDASs (WebAPIs).

One of the “smart” functionalities associated with the automated searching, is the creation of WEBDAS-Metadata by deriving from, and adding more, valuable metadata from discovered/stored WebDAS metadata, including:

1) standardization of characterizing parameters (name, endpoint, “natural language” descriptions (including any licensing terms), parameters (required, optional, additional)
2) categorization (e.g. “shopping”, “travel”, “social”)
3) matching against known information (e.g. OSS source code or, with permission, private source code),

There are two types of sources of inputs feeding WEBDAS-Database 150—WEBDAS-Data from expertise (“experts”) 50 and WEBDAS-Data from users 20.

WebDAS(es) are detected from a plurality of sources, including one or more of: 1. WebDAS creators wanting to publicize their WebDAS—submit their WebDAS to WEBDAS-Database 150 (e.g. a GITHUB-like repository of WebAPIs) (i.e. implicit “expertise” of the WebDAS creator—submitter); 2. Personally and expertly scanning the (public) Web or private organizational) locations of WebDAS). 3. Automated scanning of the (public) Web for public WebDAS (WebAPIs and associated (generic, published) metadata (e.g. name, list of parameters) and stores in WEBDAS Database 150.

The WebDAS scanned and detected in the (private) organization's software base which are proprietary to that organization, are anonymized (i.e. stripped of individual personal information and identities of individuals and the organization) and WEBDAS-Metadata generated therefrom is added to WEBDAS Database 150. For example, the behavior of such WebDAS responsive to testing (such as network traffic patterns) are useful to develop Learning/heuristics of Database 150—not only to use again for WEBDAS-Scans of the organization in the future but also as part of the learning/improvement of WEBDAS-Scans used to scan the (public) Web for WebDAS.

WEBDAS-Metadata includes, in part, categorization of detected WebDAS (“social”, “travel”, “shopping”, etc.). The categorization has an irreducible component that implicates individual expertise but can be advantageously done or supplemented to a great degree by “machine learning”. The term “machine learning” generally refers to the development and performance of computer algorithms that allow computers to recognize complex patterns and make intelligent decisions based on empirical data. A machine learning (sub)system that performs text classification on documents includes a classifier. The classifier is provided training data in which each document (here, a detected WebDAS) is already labeled (e.g. identified) with a correct label or class/category (e.g. OSS code versions for which an expert may validate for the initial training data for machine learning). The labeled document data is used to train a learning algorithm of the classifier which is then used to label/classify similar documents. The training data can be WebDAS-Metadata generated on private APIs.

Systems and techniques for improving the training of machine learning classifiers are disclosed. A classifier is trained using a set of validated documents that are accurately associated with a set of class labels. Also disclosed is a method to facilitate automatic data cleansing (e.g., removal of noise, inconsistent data and errors) of data for training classifiers.

Herein, the term “classifier” refers to a software component that accepts unlabeled documents as inputs and returns discrete classes. Classifiers are trained on labeled documents prior to being used on unlabeled documents; and the term “training” refers to the process by which a classifier generates models and/or patterns from a training data set. A training data set comprises documents that have been mapped (e.g., labeled) to “known-good”, expert-validated classes/categories of WebDAS. As used herein, the term “class” refers to a discrete category with which a document is associated. The classifier's function is to predict the discrete category (e.g., label, class) to which a document belongs.

The other source of inputs into WEBDAS-Database 150 are “Users” 20-1. Web-based software developer wants to query to see if any APIs would be useful in his/her development of software (with analogy of a literature researcher consulting a reference librarian in a book library, for books of potential value to his/her research); 2. an organization comes across software and wishes to learn more of it, so uses WEBDAS-Toolkit (“software testing jigs”) for, e.g. red flags on compliance; 3. an API developer uses WEBDAS-Toolkit to test aspects of its development of its API.

WEBDAS-Tool(s) are disclosed next.

WEBDAS-Tool for security testing. A subject WebDAS is implemented with sample data and metadata to measure performance compliance against security standards and/or best practices. Those standards may include those published by OWASP Foundation (also known as the “Open Web Application Security Project”, including testing for Injection, Broken Authentication And Session Management, Cross-Site Scripting, Insecure Direct Object Reference, Security Misconfiguration, Sensitive Data Exposure, Missing Function Level Access Control, Cross-Site Request Forgery, Using Components With Know Vulnerabilities and Unvalidated Redirects And Forwards). Those standards may include those published by PCI DSS (Payment Card Industry's Data Security Standard).

API-specific PI (Personal Information) analyzer for exposing in a subject WebDAS, all personal information implicated thereby when implemented.

Scanner for scanning an organization's plurality of software/hardware (that it has/uses for its internal purposes and/or has/uses for its products and services offered for marketplace or other external purposes) to find all instances of WebDAS (Web API, Web Services).

Various systems and techniques described herein may be implemented in digital electronic circuitry, or in computer hardware, firmware, or in combinations of them. These techniques may implement as a computer program and or software product tangibly embodied in a machine-readable storage device, for execution by, or to control the operation of, data processing apparatus, e.g., a programmable processor, a computer, or multiple computers.

Various steps described in method 1100 may be performed by one or more programmable processors executing a computer program to perform functions by operating on input data and generating output. Method steps also may be performed by, and an apparatus may be implemented as, logic circuitry or special purpose logic circuitry, e.g., an FPGA (field programmable gate array) or an ASIC (application specific integrated circuit).

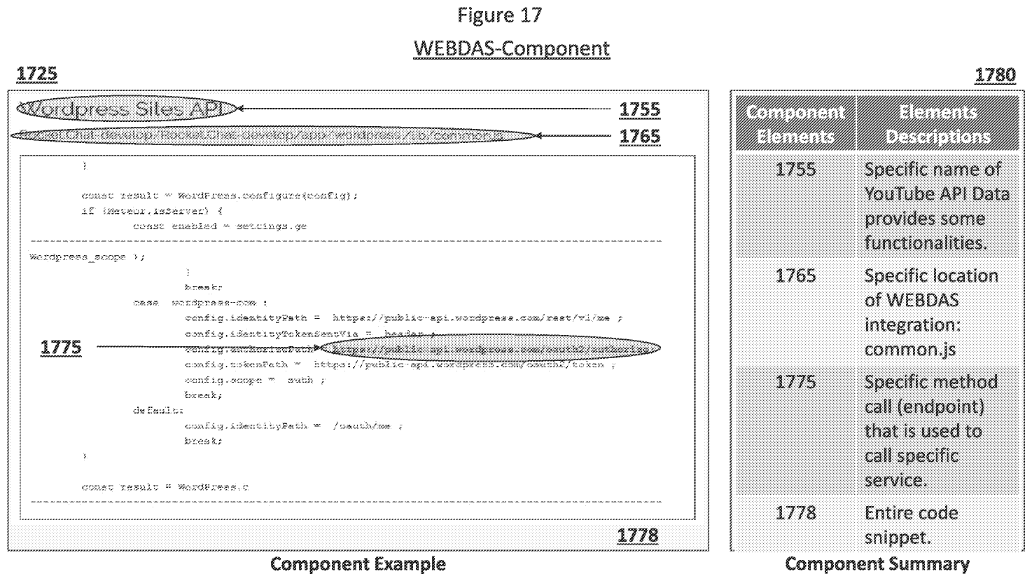

Software scanning tools and/or network traffic analysis tools can be designed to automatically detect the presence of WebDAS in organization's software applications and/or computer systems. Specific software components may be detected and identified as being WebDAS components by matching with known WebDAS-Components (which may be stored in WEBDASE-Database of all known WebDAS-Components). An example of a specific WebDAS whose components are rendered into WEBDAS-Component “YouTube Data API” is presented in FIG. 17, which lists several corresponding metadata such as specific name (1755), file location (1765), specific method or endpoint (1775).

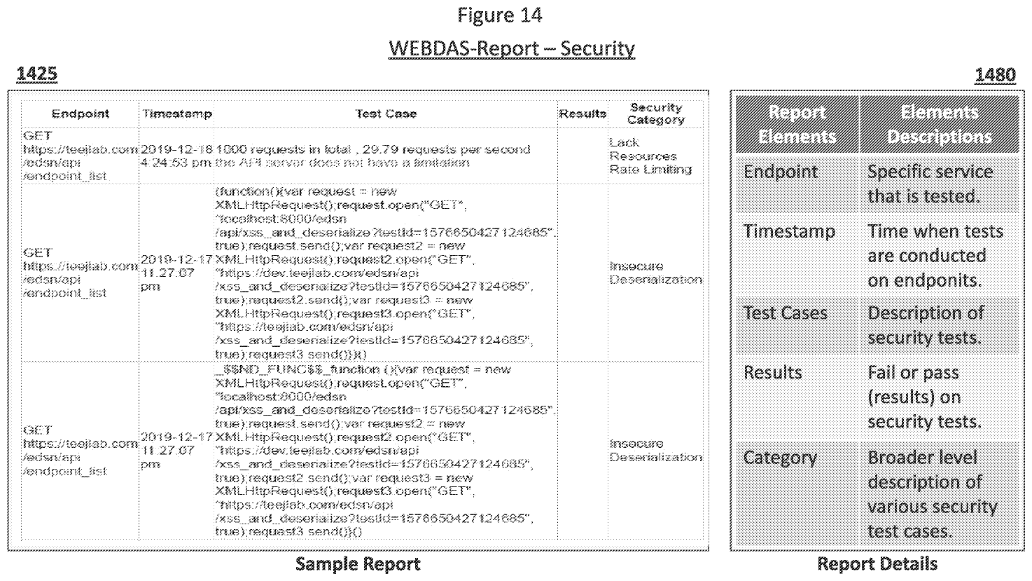

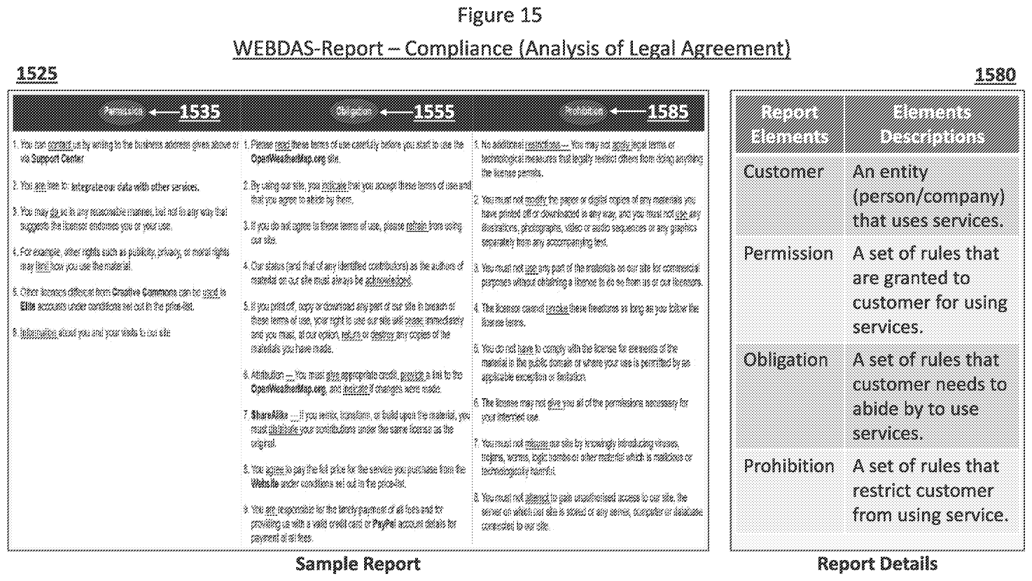

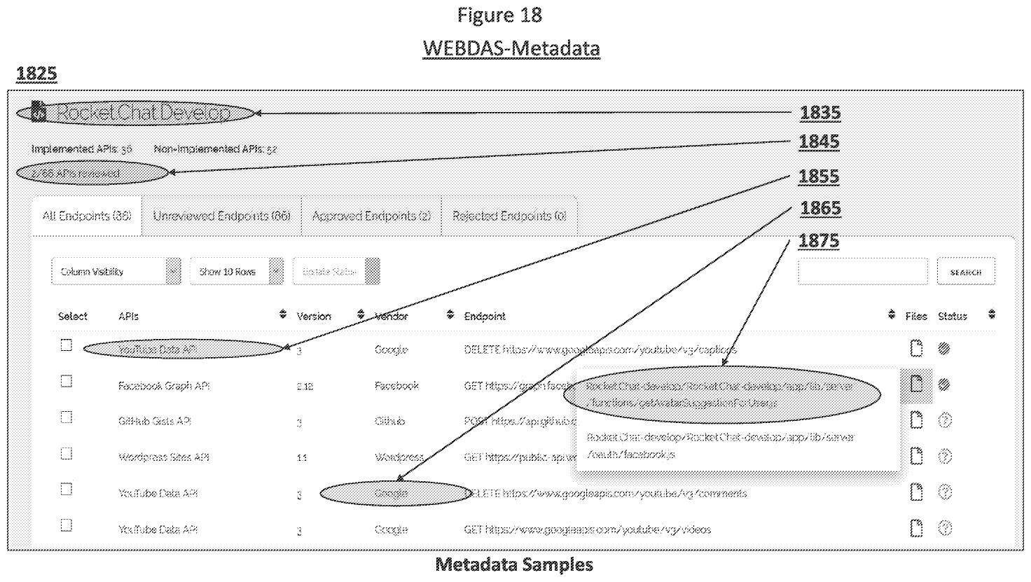

The software scanning tools and/or network traffic analysis tools can generate various other forms of metadata (WEBDAS-Metadata) including but not limited to, source and/or binary codes related to WEBDAS (1778 in FIG. 17), identification of the WEBDAS-Components (1855 in FIG. 18), the (organizations') directory locations of the WEBDAS-Components (1875 in FIG. 18), the potential origins of WEBDAS-Components, i.e., WebDAS creators (1865 in FIG. 18). Furthermore, WEBDAS-Errors data collected through WEBDAS-Implementations may provide useful information on using WebDAS successfully. Refer to FIG. 14 for some examples on WEBDAS-Errors. Similarly, WebDAS ToS, SoP and other information related to sundry technological legal or policy obligations attached to the use of WebDAS may also provide useful compliance data. Refer to FIG. 15 for some examples on Obligations, Restrictions and Prohibitions related to WebDAS usage. Attention is directed to a systematic management and analysis of all such WebDAS metadata, which results in WEBDAS-Metadata.

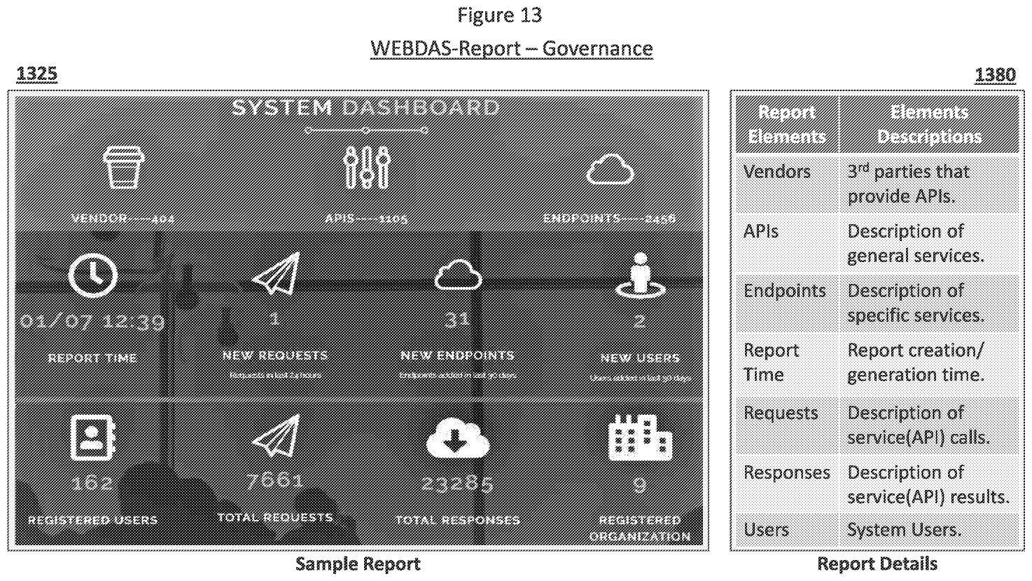

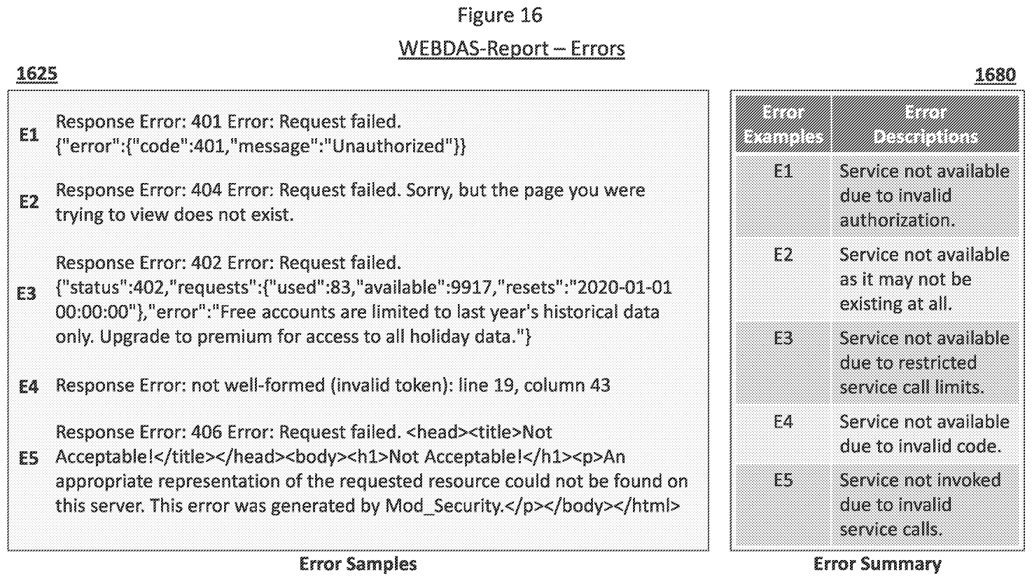

The software scanning tools and/or network traffic analysis tools may include those from non-profit organizations (e.g., Linux Foundation) and/or from commercial vendors, e.g., Palamida, Protecode, Black Duck Software, Antelink, nexB, and OpenLogic. Expertise in WebDAS management achieved through manual efforts by software developers, compliance analysts, license specialists, lawyers, and security experts may help WebDAS users in preparing various reports that are important for WebDAS compliance and/or governance. These reports may include but not limited to plans of action for license and/or security and/or quality compliance, and/or auditing of bills for using third-party WebDAS. Automatically generating various WEBDAS analytics and reports, herein collectively referred to as “WEBDAS-Reports”, is provided. An example of a WEBDAS-Report—Governance is shown in FIG. 13. An example of a WEBDAS-Report-Security is shown in FIG. 14. An example of a WEBDAS-Report—Compliance is shown in FIG. 15. An example of a WEBDAS-Report—Errors is shown in FIG. 16.

Processors suitable for the execution of a computer program include, by way of example, both general and special purpose microprocessors, and any one or more processors of any kind of digital computer. Generally, a processor receives instructions and data from a read only memory or a random-access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magneto-optical disks; and CDROM and DVD-ROM disks. The processor and the memory may be supplemented by, or incorporated in special purpose logic circuitry.

To provide for interaction with a user; methods, techniques, and processes described herein may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Methods and/or techniques and/or processes described herein may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

Also disclosed herein is a system, comprising a computer program product comprising a computer readable memory storing computer executable instructions thereon that, when executed by a computer, perform the computer-implemented method described herein. For example, the computer readable memory may reside on a custom programmable chip or customized computer system.

Also disclosed herein is a computing device, comprising a display, an internal memory and a processor coupled to the display and the internal memory, wherein the processor is configured with processor-executable instructions to perform operations comprising the method discussed above. Also contemplated herein is a communication system, comprising a plurality of computing devices coupled to a communication network, and a server coupled to the communication network, wherein the server comprises a processor configured with executable instructions to perform operations comprising the method discussed above. Further contemplated is a non-transitory computer readable storage medium having stored thereon processor-executable instructions configured to cause a processor to perform operations comprising the above discussed method.

While certain features of the described implementations have been shown as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for managing the use of a plurality of Web-based, data-driven software (“Web Service” or “Web API”) (collectively, “Network Services”), each Network Service having its associated metadata being one or more of descriptive metadata (for purposes of discovery and identification), structural metadata (on how the subject data is organized) and administrative metadata (on legal attribute), comprising:
a) developing standardized testing metadata for a first Network Service (“Standardized Test Parameters”);
b) searching the Web or relevant network to detect an instance of said Network Service by searching for said first Network Service associated metadata;
c) implementing a detected instance of said Network Service with said Standardized Test Parameters to create Responses;
d) characterizing said implemented detected instance of Network Service based on the degree of similarity of said Responses to known instances of said Network Service behaviours;
e) generating (from said characterized detected Network Service and its associated metadata) additional metadata derived from said Responses from said implemented detected Network Service based on said Standardized Test Parameters, and associating with detected Network Service to create WEBDAS-Data and/or supplement thereto; and
f) accumulating said Responses and said generated/supplemented WEBDAS-Data and then amending Standardized Test Parameters; and repeating steps a) to e).

2. The method of claim 1, wherein generating and/or receiving WEBDAS-Data includes implementing said detected Network Service through a combination of computer programming languages and/or scanning source and/or binary codebase and/or analyzing network traffic to discover Network Service.

3. The method of claim 2, wherein implementing Network Service therein includes systematic implementations of a plurality of Network Services (from a plurality of creators) in a common platform, which is a combination of software and/or hardware and/or schematic designs, to generate WEBDAS-Responses.

4. The method of claim 2, wherein scanning source and/or binary codebase to discover Network Service therein includes comparing source and/or binary codebase of software applications with the codebase of known software applications and/or databases containing Network Service.

5. The method of claim 1, wherein storing WEBDAS-Data in a database includes storing WEBDAS-Data in a relational database and/or a graph database and wherein querying WEBDAS-Data stored in a database to extract information for generating WEBDAS-Reports includes querying WEBDAS-Data using SQL and/or GQL queries.

6. The method of claim 1, further comprising tools for developers and users of a Network Service for conducting one of {security testing, compliance testing, organizational governance evaluation, Network Service-specific analyzer for personal information}.

7. A computer-implemented method for analyzing WEBDAS-Data related to software systems and components in source or binary codebase and/or text data written in natural languages, the method comprising:
generating WEBDAS-Data including identification of WEBDAS providers, components, and responses by implementing WEBDAS through a combination of computer programming languages;
receiving, by a computer, WEBDAS-Data, each data record in WEBDAS-Data including identification of a WEBDAS component in source or binary codebase and data on one or more attributes of the WEBDAS component;
storing WEBDAS-Data in a graph database; and
querying WEBDAS-Data stored in a graph database to extract information for generating WEBDAS-Reports.

8. The method of claim 7, wherein generating and/or receiving WEBDAS-Data includes implementing WEBDAS through a combination of computer programming languages and/or scanning the source or binary codebase to detect WEBDAS components therein.

9. The method of claim 8, wherein implementing WEBDAS therein includes systematic implementations of thousands of WEBDAS from various vendors in a platform, which is a combination of software and/or hardware and/or schematic designs, to generate WEBDAS-Responses containing Data Keys and Data Tags.

10. The method of claim 8, wherein scanning the source or binary codebase to detect WEBDAS components therein includes comparing code in the source or binary codebase with the code of known software systems and/or databases containing WEBDAS components.

11. The method of claim 7, wherein storing WEBDAS-Data in a graph database includes modeling WEBDAS-Data as a graph structure characterized by vertices, edges and properties.

12. The method of claim 7, wherein storing WEBDAS-Data in a graph database includes storing the modeled graph structure characterized by vertices, edges and properties in a graph database.

13. The method of claim 7, wherein storing WEBDAS-Data in a graph database includes storing the modeled graph structure characterized by vertices, edges and properties in an in-memory graph database.

14. The method of claim 7, wherein querying WEBDAS-Data stored in the graph database to extract information to put in a WEBDAS compliance, quality or security report or WEBDAS-Reports for the source or binary codebase includes querying the WEBDAS-Data stored in the graph database using graph language queries.

15. A system for analyzing WEBDAS-Data related to software systems and components in source or binary codebase and/or text data written in natural languages, the system comprising a memory and a semiconductor-based processor, the memory and the processor forming one or more logic circuits configured to:
generate WEBDAS-Data including identification of WEBDAS providers, components, and responses by implementing WEBDAS through a combination of computer programming languages;
receive WEBDAS-Data, each data record in WEBDAS-Data including identification of a WEBDAS component in the source or binary codebase and data on one or more attributes of the WEBDAS component;
store WEBDAS-Data in a database; and
query WEBDAS-Data stored in a database to extract information to put in a WEBDAS compliance, quality or security report or WEBDAS-Report for the source or binary codebase.

16. The system of claim 15, wherein the logic circuits are configured to implement thousands of WEBDAS provided by various vendors to generate WEBDAS-Responses containing Data Keys and Data Tags.

17. The system of claim 15, wherein the logic circuits are configured to scan the source or binary codebase to detect WEBDAS components using a software scanning tool and known software systems and/or databases containing WEBDAS components.

18. The system of claim 15, wherein the database is a relational database, and wherein the logic circuits are configured to store WEBDAS-Data in a relational database.

19. The system of claim 15, wherein the database is an in-memory relational database, and wherein the logic circuits are configured to store WEBDAS-Data in an in-memory relational database.

20. The system of claim 15, wherein WEBDAS-Data is modeled as a graph structure characterized by vertices, edges and properties, and wherein the logic circuits are configured to store the modeled graph structure characterized by vertices, edges and properties in a graph database.

21. The system of claim 15, wherein WEBDAS-Data is modeled as a graph structure characterized by vertices, edges and properties, and wherein the logic circuits are configured to store the modeled graph structure characterized by vertices, edges and properties in an in-memory graph database.

22. The system of claim 15, wherein the logic circuits are further configured to query WEBDAS-Data stored in the relational database and/or in-memory relation database to extract information to put in WEBDAS compliance, quality or security reports or WEBDAS-Reports for the source or binary codebase using SQL and no-SQL queries.

23. The system of claim 15, wherein the logic circuits are further configured to query the WEBDAS-Data stored in the graph database and/or in-memory graph database to extract information to put in WEBDAS compliance, quality or security reports or WEBDAS-Reports for the source or binary codebase using graph query language.
